(19) United States
(12) Patent Application Publication
(10) Pub. No.: US 2003/0024672 A1
(43) Pub. Date: Feb. 6, 2003

(54) Method and arrangement for processing a wide paper or board web

(76) Inventors: Mika Viljanmaa, Helsinki (FI); Reijo Pietikainen, Jarvenpaa (FI)

Correspondence Address: COHEN, PONTANI, LIEBERMAN & PAVANE, 551 FIFTH AVENUE, SUITE 1210, NEW YORK, NY, 10176, US

(21) Appl. No.: 10/220,514

(22) PCT Filed: Mar. 2, 2001
(86) PCT No.: PCT/FI01/00210

(30) Foreign Application Priority Data
Mar. 3, 2000 (FI) 20000497

(51) Int. Cl. D21J 1/02; B26D 5/00; B26D 5/02

(52) U.S. Cl. 162/194; 162/205; 162/135; 162/286; 83/53; 83/56; 83/177; 83/284

(57) ABSTRACT

The invention relates to a method and arrangement for processing a wide paper or board web in connection with such a manufacturing method, in which a wide base web (14) is manufactured and the base web is processed in at least one processing stage before the separation of the finished product by cutting it transversely from the web on the production line. According to the invention, the base web (14) is divided at least once to form two part-webs (17, 18) before the separation of the finished product by cutting it transversely from the web and before the final processing stage preceding separation. At least one part-web (17, 18) formed in this manner is guided to a finishing stage before the separation of the finished product by cutting it transversely from the web on the production line.

The present invention relates to a method for processing a wide paper or board web, and an arrangement for implementing the method, for example, according to the preamble to claim 1.

Paper and board manufacture is a highly capital-intensive process industry, in which the price of the end product is greatly affected by the manufacturing machinery's purchase in relation to its production efficiency. Traditionally, demands for production efficiency have been met by increasing the running speed and production width of the paper machine and finishing equipment. Both of these measures cause numerous problems in the finishing equipment, in which transverse structures, such as rolls, doctors, bearer beams, steam-boxes, maintenance decks, piping, etc. must be dimensioned to have a semicritical or critical specific frequency that is greater than the excitations arising in the machine at its design speed. This leads to very heavy and expensive constructions. The heavy rolls require large and expensive drives, gears, power supplies, and other operating equipment, if reasonable acceleration times are to be achieved. The full reeling drums, onto which the paper is reeled, are extremely heavy and demand massive drum irons and unwinders and winders, besides hoists and transfer equipment. Large rolls are relatively more demanding and expensive to manufacture than, for instance, rolls half the size. Deflection due to the self-weight of the transverse structures increases rapidly with width, causing a variety of problems.

As the web becomes wider, it also becomes more difficult to control web tension and to distribute coating substances over the width of the web. Especially in application and doctoring equipment, increased web width requires increasingly powerful compensation devices, to ensure beam straightness, an even coating-substance profile, and similar characteristics. The control of coating, calendering, and other finishing processes requires more accurate and faster control and measurement methods, which increases the demands on process-control software and measurement and control equipment.

The invention is intended to eliminate the defects of the state of the art disclosed above and for this purpose create an entirely new type of method, which allows broad webs to be handled with more economical equipment than previously, with no compromise in overall process efficiency.

The invention is based on dividing the web into at least two parts at least once before the final finishing stage and reeling, so that the part-webs can be handled with narrower equipment.

More specifically, the method according to the invention is characterized by what is stated in the characterizing section of claim 1.

The arrangement according to the invention is, in turn, characterized by what is stated in the characterizing section of claim 19.

Considerable advantages are gained with the aid of the invention.

Two narrower finishing machines cost less than a single very wide machine, because they are easier to manufacture and design. Deflections and vibrations in particular are easier to control in narrower machines. All of the machine's transverse structures, such as rolls, doctors, bearer beams, steam-boxes, maintenance decks, piping, etc. must be dimensioned to give them vibration and strength properties greater than would be otherwise required by the machine's design speed. This leads to very heavy and expensive constructions. The heavy rolls demand large and expensive drives, gears, power supplies, etc., to achieve reasonable acceleration times. The full reeling drums are very heavy and require massive drum irons and unwinders and winders. The thermo-roll of a calender, for example, can be the entire mill's heaviest component, thus determining the dimensioning of hoists, roll-grinders, etc. and causing indirect costs. The larger rolls presently being used are relatively more demanding and expensive to manufacture than, for example, rolls half their size, while deflection due to the self-weight of rolls and other transverse structures increases with width, causing a variety of problems. If a machine's width is halved, the effects of such problems decrease more rapidly than the width of the machine. Narrow machines can be dimensioned dynamically to be faster, with pilot runs showing no quality deterioration due to increased speed. Thus, total production can be increased without widening the machine. The web can be divided at any stage at all in a paper or board machine, if the durability or support of the web is sufficient for guiding it. The earlier the stage at which the division is made, the cheaper it becomes to bring the part-web back into production if a break occurs. It is especially advantageous to take the web to the pulper before coating, so that the coating need not be removed from the material to be recycled. Production can then be continued normally on the parallel line/s. This method permits one-line technology to be used to manufacture different paper grades from a single base-paper web. It is then possible to envisage one part of the web being coated and calendered and the other being led uncoated directly to a newspaper printing press, thus eliminating unwinding and winding. This solution is particularly suitable for mills, using recycled fibre, planned in the vicinity of urban areas.

Narrower webs are more resistant to stress during manufacture and finishing even when wet, so that when manufacturing base paper the process can be optimized according to desired properties other than strength. It is even possible to envisage using processing equipment with a total width greater than the greatest width of the web. This permits altering the cutting point of the part-webs and their widths and, for example, cutting a desired part of the web, according to the web tension and thickness profile, for a certain type of finishing, and another part for a different purpose. This can be done, for example, by using spray-coating and a calender, which allow the treatment width to be adjusted. The possibility of manufacturing two different paper grades from a base web eliminates grade changes the paper machine. This considerably increases the plant's productivity by reducing downtimes. A further possibility to use the invention to gain greater production flexibility is to finish part of the web directly as sheets and to reel the remainder as customer reels.

One possible way to exploit the invention is to use a single narrower calender to process both part-webs. In principle, this calender solution combines two separate smaller calenders, which simultaneously calender the bifurcated paper web, to form a single calender totality, which simultaneously calenders two narrow paper webs and is half the width of present calenders or the paper machine making the paper to be calendered. For example, two parallel 6-roll on-line-Optiload calenders handling a bifurcated web can be combined to form a single 12-roll on-line machine. One web is then calendered in the fifth uppermost nip and the other correspondingly in the fifth lowest nip. Naturally, the webs that were originally parallel must be guided laterally to enter the calender on top of each other. The easiest way to do this is to place the calender on the centreline of the paper machine, minimizing the need to move the part-webs laterally.

The part-webs cut from the paper web can also be led to the calender from opposite sides. It is then best to locate the calender transversely to the line of the paper machine, when the web transfer must be designed to turn the web through 90°. This solution has the advantage of allowing a more precise utilization of the calender's nips.

The particular advantage of this solution is that it not only solves the problems of wide machines referred to above, but that it also, compared to two narrow on-line machines operating in parallel, requires only a single machine's frame and ancillary equipment, such as hydraulics and roll-heating equipment, and the takes up much less hall space. Instead of the four deflection-compensated rolls in two narrow machines, only two such rolls are required. Each web can be profiled almost independently of the other, one with the upper roll, the other with the lower roll, provided that one-sided profiling is sufficient. The profiling taking place with the upper or lower roll scarcely extends through the sets of rolls of a multiroll calender to the other web. A paper web divided into two separate webs narrows the entire finishing end of the production line by a half, in principle making all equipment, such as cutters and reelers, one-half smaller, bringing considerable cost savings. The vibration-related dimensioning of modern larger calenders is much easier in machines that are substantially narrower. If it is wished to calender both webs in the same way, the calender must be run like a fully lightened Optiload calender, in which the nip loads can be set independently. However, if it is wished to produce differently calendered papers from the same production batch, partial lightening can produce two different calendering grades.

Realized orders, for example, can be used to calculate an estimate of the cost savings that can be achieved. In the following calculation, softcalender 1 is a full-width calender while softcalender 2 is half the width of softcalender 1. The figures given are only comparative and indicate the relative prices of the calenders.

| | softcalender 1 | softcalender 2 | 2 × 2 complete |
|---|---|---|---|
| price of basic machine | 57.4 | | |
| (unit) | | | |
| ancillary equipment | 20.9 | | |
| total machine price | 71.3 | 37.9 | 75.8 |
| spare rolls, start-up | 28.7 | 10.9 | 21.8 |
| spares etc. | | | |
| Total | 100 | 48.8 | 97.6 |

The table shows that two separate softcalenders complete with all spare rolls and start-up spares cost 2.4% less than a single corresponding full-width machine. Further, if only a single set of start-up spares, spare rolls, etc. is supplied with two complete narrower machines, the two machines will cost 13.3% less than a full-width machine. Considerable additional savings, which are not estimated here, accrue from project-specific design costs, which are nearly halved for each machine if two identical machines are made instead of one, and from the manufacturing costs. This case also does not take account of the savings arising when common systems, such as the heating system, the control room and its equipment, etc. can be used for both of the two machines. In terms of the whole line, having two narrower calenders instead of a single full-width machine ensures that the whole line need not be stopped in the event of roll damage, for example, as one calender can continue production, with half of the incoming web being run to the pulper during the break and the other half of production being obtained as customer reels. However, with two machines the total breakdown frequency will be higher. On the other hand, the pulp and liquid circulation systems can be maintained by running ⅔ or ¾ of a machine, when, depending of the process stage, part of the web may go straight to the pulper. If the web is divided already at the head-box, the feed to the closed part of the line can be stopped entirely.

All in all, it can be stated on the basis of the above, that dividing the web into two or more part-webs will significantly reduce the finishing equipment investment costs.

In the following, the invention is examined with the aid of examples and with reference to the accompanying drawings.

For the sake of simplicity, the following description only refers to a paper machine, but the invention can be applied in an entirely corresponding manner to board machines. Division may be even more advantageous in board machines, as the product spectrum is broader, ranging from printing and packing boards to board grades that are impermeable to liquids or even gases, and requiring various process equipment for their manufacture.

The term part-web refers to a part cut from the web, which may be either a finished product, or a part of the web intended as a base for a finished product. The term part-web does not refer to edge strips or other parts that must be removed from the web.

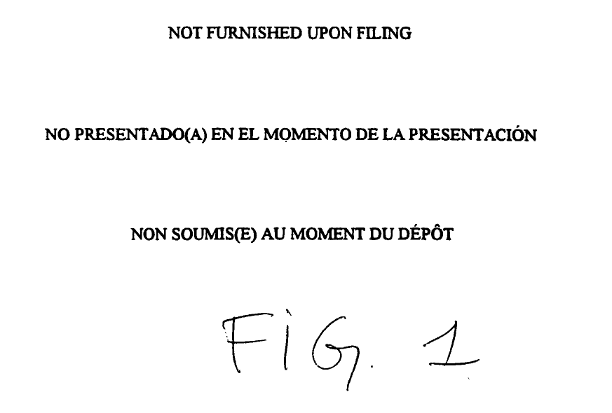

FIG. 1 shows a diagram of one typical papermaking line, which comprises a paper machine and finishing equipment connected directly to it.

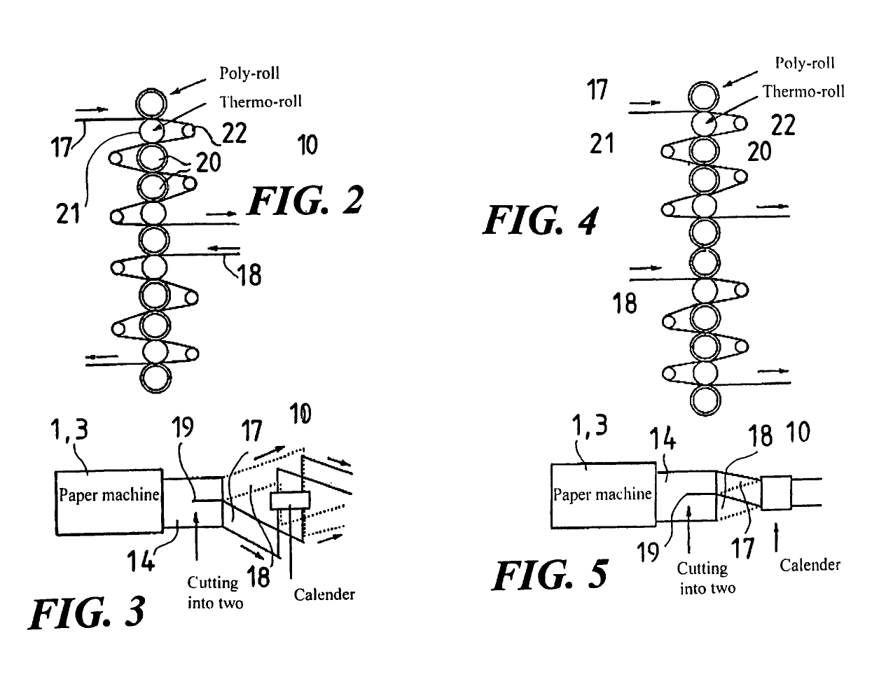

FIG. 2 shows a diagrammatic side view of one calendering method suitable for applying the invention.

FIG. 3 shows a diagrammatic top view of the calendering method of FIG. 2.

FIG. 4 shows a diagrammatic side view of one calendering method suitable for applying the invention.

FIG. 5 shows a diagrammatic top view of the calendering method of FIG. 4.

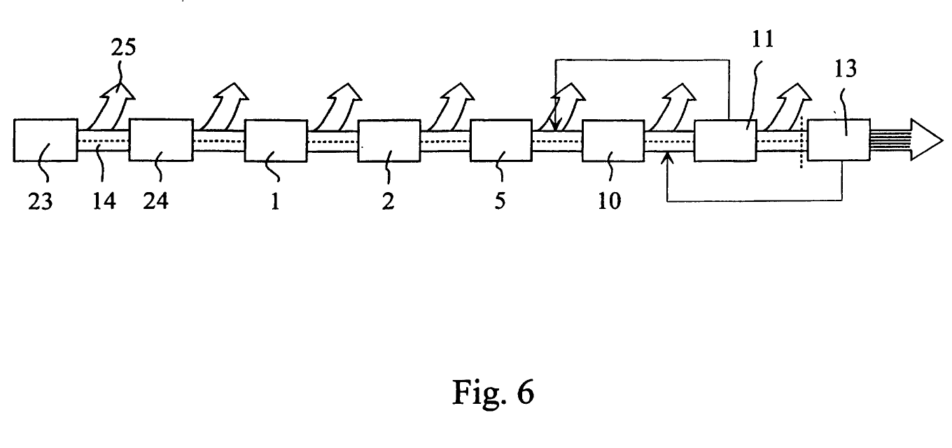

FIG. 6 shows a diagrammatic top view of various possible ways of implementing a papermaking line.

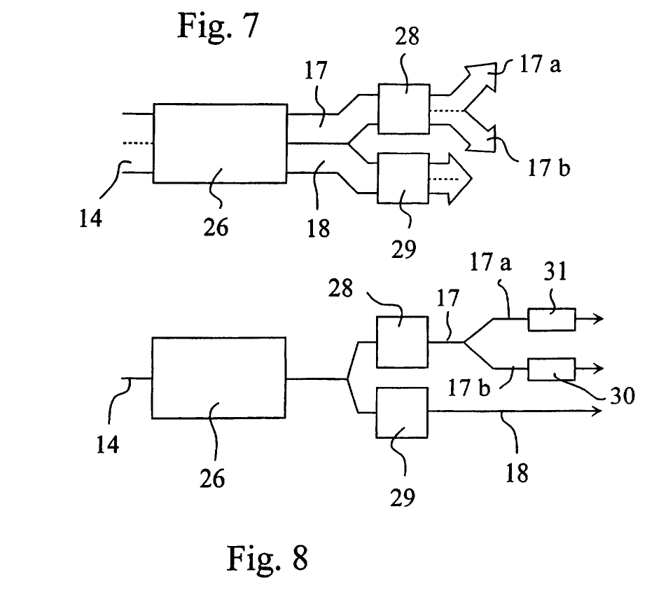

FIG. 7 shows one way of guiding the webs when dividing the web into two parts.

FIG. 8 shows another way of guiding the webs when dividing the web into two parts.

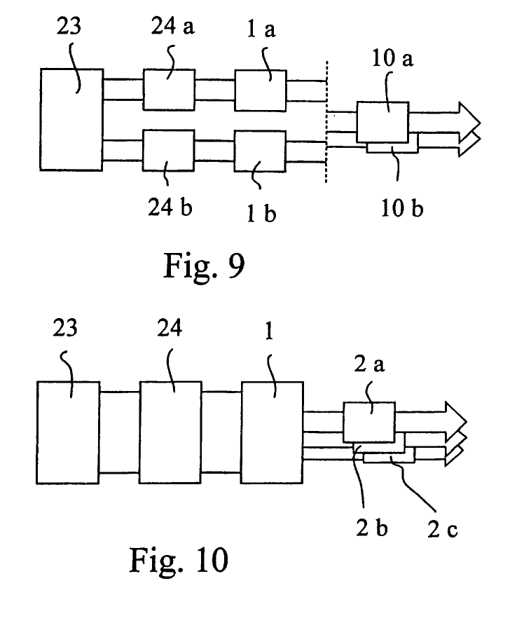

FIG. 9 shows the division of the webs immediately after the head-box.

FIG. 10 shows the division of the webs immediately after the press-section.

FIG. 1 shows a typical modem papermaking line used to manufacture paper coated once on both sides and calendered in a multinip calender. The figure does not show the web-formation section of the paper machine and indeed starts at the machine's press section 1. Press section 1 has two long-nip presses. In them, the web 14, which has been made in the formation section and contains a great deal of water, travels supported by felts or wires through a nip formed by a press-shoe and a flexible roll surface or a belt. The pressure in the nip removes a great deal of water from web 14. greatly increasing its dry-solids content, thus facilitating handling of the web. From press-section 1, web 14 is guided over a continuous support to dryer section 3. which comprises several drying cylinder groups 4. In drying cylinder groups 4, web 14, from which water continues to be evaporated, continues to travel supported by felts or wires over the heated cylinders. Usually, dryer section 3 is used to dry base web 14 to its final moisture content, when it also achieves its final strength. However, there are several control and adjustment methods for pressing and drying, the removal of water from web 14 being regulated according to the grade of paper to be produced, to emphasize the desired properties in the base paper. The most important properties for runnability are the strength and even quality of the web, so that it will withstand stress easily and the tensions in it will be as even as possible.

FIG. 1 shows an on-line paper machine, with finishing equipment placed as a direct extension of the paper machine and the web continuing straight to the finishing stages. In our example, web 14 is coated simultaneously on both sides in a two-sided film-transfer coater 5. In such a coater 5, the web travels between a nip formed by two application rolls, which both spread the coating with an application device. In the nip, the coating substance transfers from the surfaces of the rolls to the surface of the base paper. As both sides of web 14 are wet after two-sided coating, web 14 cannot be supported using contact-support devices. The web is therefore guided to an airborne web-dryer 6 with an integrated air turning device, which changes the direction of travel of web 14. After the airborne dryer, web 14 has dried enough to be guided to a reversing cylinder 7, which changes its direction towards a second airborne dryer 8. If non-contact support is desired at this stage too the reversing cylinder can be replaced with the blower cylinder of an air turning device, which blows air between the web and the cylinder. The web is led from the second airborne dryer 8 to drying-cylinder group 9 and then to calender 10. In this case, calender 10 is a multinip calender, for example, a well-established supercalender, or a newer Optiload or Janus-Concept calender, which have better nip-load control and adjustment than a supercalender. From calender 10 web 14 is guided to reeler 11, which reels the web onto drum reels 16. The drum reels 16 are then transported over slides 15 to slitter-winder 13. which cuts the drum reels into narrower customer reels.

In several places under the paper machine line and finishing equipment there are pulpers, to which the web being made can be guided if a web break occurs in the line after the pulper.

FIG. 1 shows only one possible production line comprising a paper machine and finishing equipment. The present invention can be applied in all paper and board production lines incorporating finishing equipment and also in off-line finishing lines. Production lines can include various calenders, such as soft, machine, and multinip calenders, various coaters, such as jet, spray, film-transfer, short-dwell, and blade coaters while the web can be coated several times. As the invention is based on dividing the web into at least two parts, the separate web parts can be processed in different ways, for example, uncoated calendered paper can be made from one part of the web and coated paper from the other.

FIGS. 2 and 3 show one way to divide web 14 into two part-webs 17, 18. Web 14 is made in paper machine 1, 3, after which it is led to cutting 19. Cutting preferably takes place with a disc cutter, which gives the best edge quality, or by other cutting methods, such as a water-jet or laser, which have the advantage that the cutting member, the water-jet or laser-ray, need no servicing or replacement. After cutting 19, the web is divided into two part-webs 17 and 18. Of these, part-web 17 is guided towards the machine's centreline, part-web 18 being also guided to the centreline but downwards. Calender 10 is set on the centreline of the machine, with the calender rolls set transversely to the centreline. FIG. 2 shows how part-webs 17, 18 are brought to the calender and guided though it. Part-web 17, which is guided upwards, is led to the nip between the calender's uppermost soft roll 20 and hard roll 21, from where guide rolls 22 transport it through a total of four calendering nips. There is no nip between the two soft rolls 20 shown in the figure, instead, part-web 17 travels freely between these rolls. Correspondingly, part-web 18 is taken to the middle of the set of rolls of calender 10 and guided through the rolls in the same way as the upper part-web. Here, the manner of guiding the webs depends on the direction of rotation of rolls 20, 21, which must be such that the roll surfaces in nip contact move in the same direction. This solution has two 5-nip on-line Optiload calenders combined as a single 12-nip calender, resulting in simpler construction and equipment than in two separate calenders. Naturally, in this case the webs, which originally ran parallel to each other, must be guided laterally as disclosed above, to enter the calender on top of each other. The easiest way to do this is to place the calender on the centreline of the paper machine, thus minimizing the need to move the part-webs laterally.

One possibility is to lead the part-webs cut from the paper web to opposite sides of the calender. It is then best to set the calender transversely on the centreline of the paper machine, with the web transfer arranged to turn the web through 90°. This solution has the advantage of exploiting the nips more fully, as all the nips in the roll surfaces are used. Compares to the previous embodiment, one soft roll is saved in the middle of the roll set.

The operation and construction of the Optiload calender described above will be known to one versed in the art and as such does not relate to the application of the invention. This invention can be applied equally as well to other calenders, such as softcalenders, using, for instance, the above methods to guide the part-webs. However, the web can also be guided to separate calenders, which can even be located on different floors of the mill building, or the webs can be guided to the side away from the machine's centreline, to a location in the building with space for the calenders. Known reversing irons, air turning devices, guide rolls, or other known turning devices can be used to guide the web. As the web guiding is, as such, well known from various paper machines and printing presses, the turning devices are not described here in greater detail.

If the web is divided before the coating station, it is often preferable to use dedicated coaters, which can be of similar of different types, for each part-web, allowing two different paper grades to be made. Obviously, if the web is divided before coating, each part-web must correspondingly have its own dryer and, if necessary, its own calender. One interesting manufacturing method is to first coat the base paper once on both sides, then divide it into two part-webs, one being, for example, calendered and the other coated a second time and then perhaps calendered. Naturally, different types of calenders can be used for the separate part-webs. If the base web is sufficiently wide, it is quite possible for there to be several part-webs wide. The application of the invention is not dependent on the type of coater or calender used, as the idea is applicable to all equipment used to manufacture paper or board.

The finishing equipment of the papermaking line in FIG. 1 is relatively simple, because it coats both sides of the paper in a single stage, followed by a single calendering stage. If the paper is coated several times and precalendering is used before calendering, the line will be very much longer and more complex. A more complex line will provide more possible ways to apply the invention, as it will have more places where the web can be divided into sub-webs. In principle, the pulper locations on the line of FIG. 1 are natural places to divide the line, because there the web moves from one process stage to another. Thus, in FIG. 1, it is preferable to divide the web between press section 1 and dryer section 3, between dryer section 3 and coating station 5, or between coating-station dryers 6-9 and calender 10. As already stated, a line comprising several process stages has several potential web-division locations. According to one important embodiment of the invention, at least one part-web is led to reeling and at least one to a sheet-cutter.

FIGS. 6-10 show various ways of implementing the invention. In FIG. 6, the web is manufactured by feeding a mixture of water and fibre pulp from head-box 23 to former 12, which forms a cohesive web from the fibre pulp. At this stage, the web contains very much water, so that it cannot be guided without support. The web can, however, be divided immediately after head-box 23, when separate formation-section wires, for example, must be used to support the part-webs. This would permit the use of a dividable head box 23, from which the pulp feed to one part-web could be shut off during maintenance, grade changes, or web breaks, thus totally eliminating the need to recirculate this part of the pulp. Each divided part-web, shown by an arrow 25, can be guided forward down the manufacturing line along with the other part-webs, or it can be guided to the side to its own processing line. The next point at which the web can be divided is between web former 24 and press section 1. Even at this stage, the web's cohesion is poor, so that it must be supported with a wire, felt, or other means. After press section 1. enough water has been removed from the web for it to be transported without support, facilitating web division. Division is simplest after the drying that takes place after drying 2 and calendering or coating 5, as the web is then driest and most resistant to handling. Division taking place immediately after coating 5 must allow for the fact that web 14 usually cannot be touched on its wet, coated side. Though the web can still be divided at winder 11, this may not be advantageous, if the reels on the reeling drum are taken straight to slitter-winder 13. One or all of the part-webs can be taken to a sheet-cutter, instead of to a slitter-winder.

As FIG. 6 shows, part-webs 25 can be separated from the base web or main web at any stage of manufacture at all. However, it is essential that at least one part-web is separated from the base web with a cut parallel to its direction of travel, before the product is separated, with a transverse cut, from the web or webs moving on the production line, and before the final processing taking place prior to the transverse cut.

FIG. 7 shows one principle for dividing web 14, in which part-webs 17, 18 are guided to the side away from the direction of travel of the base web. The figure shows a top view of the division. In this principle, web 14 comes to a first processing device 26. after, or by which it is divided into two (or more) part-webs 17, 18. Part-web 17 is guided to a second processing device 28 and, after processing, divided again into two (or more) narrower part-webs 17a and 17b. Part-web 18 is led to a third processing device 29. In FIG. 8, which shows a side view of the web division, the division takes place in the same way, except that the webs are guided to travel on top of each other, and the processing devices after the division are also on top of each other. The different ways to guide the part-webs are chosen according to the space available and can be combined, with, for instance, two webs guided on top of each other and a third guided to the side. As FIG. 6 shows, such a division can be made at any stage at all of papermaking. To illustrate this, FIG. 9 shows the web being divided immediately after the head-box, in which case two web formers 24a and 24b. and otherwise doubled processing devices, such as calenders 10a and 10b, are used. In FIG. 10, division takes place before the drying section, so that the divided part-webs, in this case three, are guided to separate dryer lines. The said processing devices are thus either devices used for web formation itself, such as the web former, the press section, or the dryer, or else finishing devices, such as calenders, coaters, or surfacing devices. In this case, the term processing device refers to a device that actively affects the web's properties, but not to devices used to control the web, such as rolls, turning devices, and reelers. Part-webs can be guided simultaneously parallel to and/or on top of each other while division can take place from the head-box, web former, press section, dryer section, coater section, or calender. The part-webs can be finished products or they can be used as bases for products requiring further processing.

An advantageous way of dividing the web is to select part-web widths that are optimal for a specific purpose. Usually, the base web has the most even quality in the middle, as the edge areas of the web have different characteristics, with variations occurring, for example, in thickness, moisture content, and tension. One factor affecting the calibre of the web is that the pressure created by the various nips is greater at the edges of the web. In some cases, one edge of the web is thicker than the other, so that the part of the web with the best target quality may be at either edge of the web. If this fact is used to try to optimize the quality of the part-webs cut from the web, it is preferable to use finishing devices with an adjustable width, or which operate independently of the width of the web to be processed. Such devices include spray coaters and some calender types. Control will be most successful, if the web is divided into at least three parts, which is essential, if an attempt is made to use one part-web from the centre of the base web. If necessary, the web can of course be divided even several times in subsequent stages. Though desired parameters can be used to select part of the web, optimization naturally requires the measurement of the dominant property, before dividing the web. One excellent indicator of web quality is the tension profile, according to which the division can be made.

The invention can also be applied in off-line finishing, in which case, the web is divided, for example, after the first, second, or possibly even third coating stage, and preferably after the drying stage following coating. In this case, the part webs are guided to either the next coating stage or to a calender. Of course, the web can even be divided immediately after coating before drying, but this has the problem that direct contact cannot be used to guide or support the wet web. Thus, it is easier to guide and turn a dried web.

The above disclosure refers principally to the manufacture of paper. Obviously, the same principles can also be applied to the manufacture of board. Similarly, the aforesaid coating also includes surface sizing and other similar methods, in which a coating substance is spread onto a base web.

1. A method for processing a wide paper or board web in connection with such a manufacturing method, in which a wide base web (14) is manufactured and processed in a least one processing stage before the finished product is separated by being cut transversely from the web on the production line, wherein the base web (14) is divided at least once, to form at least two part-webs (17, 18), before the finished product is separated by being cut transversely from the web on the production line and before the processing stage prior to separation, and at least one part-web (17, 18) is guided to at least one finishing stage, before the finished product is separated by being cut transversely from the web on the production line, characterized in that the part-webs are guided parallel to or on top of each other and are divided from at least one of the following devices: head-box, web-former, press, drying section, coating section, or calender.

2. A method according to claim 1, characterized in that the part webs (17, 18) are guided laterally towards the centreline of the machine, on top of each other.

3. A method according to claim 1, characterized in that at least one of the part webs is guided to the side, away from the centreline of the machine.

4. A method according to claim 3, characterized in that the part-webs (17, 18) are guided to a processing device oriented at an angle to the centreline of the machine.

5. A method according to claim 2, characterized in that the part-webs (17, 18) are guided to a calender (10), in which there are nips set on top of each other to process each part-web (17, 18).

6. A method according to claim 4, characterized in that the part-webs (17, 18) are guided to a processing device set transversely to the centreline of the machine.

7. A method according to claim 4, characterized in that the part-webs (17, 18) are guided to a calender (10), set transversely to the centreline of the machine, in which there are nips set on top of each other to process each part-web (17, 18).

8. A method according to claim 1, characterized in that at least one quantity affecting the quality of the finished product is measured and the base web (14) is divided into part-webs on the basis of the result of the measurement, in order to select the best part of the web in terms of this quality characteristic.

9. A method according to claim 1, in which the base web (14) is dried, first by pressing (1) and then by heated dryers (3), characterized in that the base web (14) is divided after the press-drying of the web.

10. A method according to claim 1, characterized in that at least one part-web (17, 18) divided from the base web (14) is led directly to a printing press.

11. A method according to claim 1, characterized in that the base web (14) is divided before coating.

12. A method according to claim 1, characterized in that at lest two part-webs are processed differently after being divided, to create different finished products.

13. A method according to claim 7, characterized in that the tension profile of the base web (14) is measured and is used to decide the manner of the division of the web.

14. A method according to claim 1, characterized in that at least one part-web is guided to a winder and at least one to a sheet-cutter.

15. A method according to claim 2, characterized in that at least one part-web is guided to at least one coating station.

16. A method according to claim 3, characterized in that at least one part-web is guided to at least one coating station.

17. A method according to one of claims 1-16, characterized in that the web is divided after one of the following processing devices: head-box, web-former, press, drying-section, coating section, or calender.

18. An arrangement for processing a wide paper or board web on a manufacturing line that comprises devices (1, 3) for manufacturing a wide base web (14) and at least one processing device (10) for processing the base web (14) in at least one processing stage before the separation of the finished product by cutting it transversely from the web on the production line, means (19) for dividing the base web (14) into at least two part-webs (17, 18) before the separation of the finished product by cutting it transversely from the web on the production line and before the final processing stage preceding separation and by a means for guiding at least one part-web (17, 18) to at least one processing stage, characterized means for guiding part-webs parallel to or on top of each other and dividing the part webs from at least one of the following devices: head-box, web-former, press, drying section, coating section, or calender.
